(19) United States
(12) Patent Application Publication
(10) Pub. No.: US 2014/0036503 A1
(43) Pub. Date: Feb. 6, 2014

(54) DROP CEILING LIGHTING TECHNIQUES

(71) Applicant: Joseph Allen Olsen, Gloucester, MA (US)

(72) Inventor: Joseph Allen Olsen, Gloucester, MA (US)

(73) Assignee: OSRAM SYLVANIA INC., Danvers, MA (US)

(21) Appl. No.: 13/565,059

(22) Filed: Aug. 2, 2012

(51) Int. Cl. F21S 8/04; F21V 8/00; H01R 43/00; F21V 7/00

(52) U.S. Cl. 362/249.02; 362/382; 362/296.01; 362/249.01; 362/612; 362/613; 362/235; 29/825

(57) ABSTRACT

Techniques and architecture are disclosed for integrating lighting into a dropped/suspended ceiling. In some cases, a light source (e.g., light emitting diodes, laser diodes, etc) can be operatively coupled with the support grid/matrix of a drop ceiling. In some instances, the light source can be mounted on the underside of a drop ceiling T-frame and configured to emit/direct light sideways and/or downward from the ceiling. In some other instances, the light source can be mounted on an interior portion of a T-frame and configured to emit/direct light: (1) into an adjacent lightguide configured to direct the light downward from the ceiling; and/or (2) onto an adjacent reflective ceiling tile configured to direct the light downward from the ceiling. Some such lighting fixtures can be configured to be substituted for a standard or custom drop ceiling tile.

### FIELD OF THE DISCLOSURE

The invention relates to lighting fixtures, and more particularly to lighting fixtures for use with reconfigurable infrastructure.

### BACKGROUND

Lighting in drop ceiling applications is currently accomplished using downlight cans (e.g., 2″ or 6″) or troffers (e.g., 2′×4′ or 2′×2′). In either case, the lighting fixtures are typically hardwired to a 120VAC supply line. In some cases, a DC supply can be used. For instance, in an EMerge Alliance® grid, typical light fixtures like downlight cans are retrofitted with 24VDC drivers and LEDs are attached to full ceiling tiles. Some 2′×2′ edge-lit fixtures are also commercially available where the LEDs are mounted in custom aluminum extrusions that make up the edge-lit fixture frame. The edge-lit fixture frame holds the LED boards, the light guide, the reflector sheet on the back side, collimating and diffusing optic sheets on the front side, and supports the 24VDC driver electronics on the back. The assembled edge-lit fixture is dropped into and sits in the grid matrix of the suspended ceiling framework in place of a standard ceiling tile or standard troffer.

### BRIEF DESCRIPTION OF THE DRAWINGS

FIGS. 1a and 1b each illustrate a schematic side view of an example drop ceiling support grid configured with integrated lighting in accordance with an embodiment of the present invention.

FIG. 2 is a schematic side view of an example drop ceiling support grid configured with integrated lighting in accordance with another embodiment of the present invention.

FIG. 3 is a schematic side view of an example drop ceiling support grid configured with integrated lighting in accordance with another embodiment of the present invention.

These and other features of the present embodiments will be understood better by reading the following detailed description, taken together with the figures herein described. The accompanying drawings are not intended to be drawn to scale.

### DETAILED DESCRIPTION

Techniques and architecture are disclosed for integrating lighting into building infrastructure materials. In particular, and in accordance with some embodiments, grid pieces that form a support matrix commonly used to support tiles of a suspended ceiling can be configured with LEDs. In some such cases, LEDs on printed circuit boards can be attached to the metal grid either sideways or pointing down. In cases where the LEDS are mounted sideways, the light can be directed by using, for instance, a lightguide panel making it an edge-lit ceiling panel. In other cases, the light can be directed downward by, for example, raising the ceiling tile a small distance or lowering the LEDs to use the ceiling tile as a reflector to send the light downward. In still other cases, the LEDs can be mounted to directly shine downward by positioning them on the underside of the grid. A diffuser may be desirable in various direct lighting applications as may indirect lighting.

General Overview

As previously explained, lighting in drop ceiling applications is currently accomplished using downlight cans or troffers. Typical light fixtures like downlight cans are fitted into ad hoc holes of ceiling tiles. In the case of troffers such as edge-lit fixtures, the LEDs are mounted in custom aluminum extrusions that make up the edge-lit fixture frame. The assembled edge-lit fixture, including the LED containing frame and fixture, is dropped into and sits in the grid matrix of the suspended ceiling framework in place of a standard ceiling tile or standard troffer. As will be appreciated in light of this disclosure, the metal structure of the drop-ceiling grid provides much of the same functionality as the frame of an edge-lit fixture (or other such fixture frames), which effectively results in duplication of effort, extra cost, extra material usage, and weight that has to be supported. In addition, some applications facing increased demands, such as those where structures must be earthquake proof, the various extra material and weight burden can be excessive.

Thus, and in accordance with an embodiment of the present invention, lighting techniques are provided that effectively leverage existing infrastructure so as to allow for a reduction in materials and weight, as well as cost. In some cases, the techniques eliminate need for the LED-containing frame in the lighting fixture by using the drop ceiling support grid to support the LEDs. In more detail, standard drop ceiling construction generally employs a metal grid for holding the suspending ceiling tiles in place. The grid is often in the shape of an inverted T and placed so that square ceiling tiles having typical dimensions of 2′×4′ or 2′×2′ can drop into the horizontal catches of the inverted T and the tile edges are hidden from view. The grid is typically extruded aluminum but other suitable materials and forming techniques can be used as well.

In accordance with one specific embodiment of the present invention, a lighting system is provided that includes an edge-lit ceiling panel fixture configured to be dropped into a metal grid/matrix constructed with an extruded metal frame having the inverted T shape. The LEDs that illuminate the fixture are mounted separately from the fixture and can be, for example, surface-mount soldered onto printed circuit boards along with other electronics if so desired, such as voltage regulator, ballasting circuitry, etc. The printed circuit boards with the LEDs can then be screwed or otherwise securely fastened to appropriate T-shaped portions of the drop ceiling grid in such a way so as to position the LEDs to shine into the waveguide and associated optics of the edge-lit fixture placed into the grid in a similar fashion as a standard ceiling tile. Note that the printed circuit boards can be secured to the metal (e.g., aluminum) T-shaped grid using any suitable fastener to provide good thermal contact, such that the grid further provides heat sink functionality.

In other embodiments, the LEDs and other necessary components can be mounted directly into or otherwise on appropriate portions of the drop ceiling grid (without a printed circuit board). As will be appreciated, such direct placement of the LEDs and any components will depend on factors such as the insulative nature of the packaging of the LEDs and components, the interconnection of those components, and the material from which the drop ceiling grid is made. For instance, if the grid is metal or otherwise conductive (e.g., aluminum or steel), then the packaging of the LEDs and any components touching the grid directly would need to be either insulative (so that there is no electrical conduction through the LED/component packaging into the grid) or tied to earth ground (where the LED/component packaging is tied to the ground pin of the packaging). For LED/component packaging that is not amenable to such an application, an intervening electrically insulating layer of some kind can be used where the LED/components are electrically isolated from the conductive grid by the insulating layer (which may be, for example, an insulative tape or conformal coating placed on the conductive grid portions where the components will be directly coupled. Alternatively, if the drop ceiling grid is non-conductive (e.g., extruded plastic such as PVC, fiberglass reinforced plastic, or other suitably strong but non-conductive material), then the grid could effectively be populated in a similar fashion to a printed circuit board or other substrate, as will be appreciated in light of this disclosure.

Thus, in some example embodiments, the light source can be mounted on any suitable portion of a support grid of a drop ceiling and configured to emit light: (1) generally downward and/or laterally into the room; (2) laterally into an adjacent lightguide configured to direct the light downward into the room; and/or (3) laterally into an adjacent troffer configured with a reflective ceiling tile configured to reflect or otherwise direct the light downward into the room. The edge lit lightguide or reflective ceiling tile may be configured (e.g., size, weight, etc) to be substituted, for instance, for a standard drop ceiling tile and that can securely sit within the grid. Note that the light sources, which can be LEDs or any other suitable light source, can be operatively coupled or otherwise integrated with one or more interior and/or exterior portions of the drop ceiling support grid. Further note that the light source and/or any other necessary electronic circuitry can be populated on a printed circuit board that is operatively coupled to the support grid, or directly on the grid itself without an intermediate PCB or other mounting platform. In the latter case, an insulating conformal barrier layer may be deployed between the LEDs/component as necessary.

The techniques can be readily implemented with existing infrastructure and can be further used to reduce duplication of effort and materials allowing for a significant cost savings. Furthermore, some embodiments may realize a reduction in fixture design complexity, given that the light source need not be housed within the frame of the lighting fixture. Still further, some embodiments may realize a reduction in the weight of the design, given that unnecessarily duplicative structures/materials can be omitted (e.g., such as framework for holding LEDs in edge-lit lighting fixtures). Still further, some embodiments may realize an increase in optical efficiency as compared to the aforementioned existing edge-lit lighting fixtures. Other advantages/benefits associated with one or more embodiments of the present invention will be apparent in light of this disclosure. As will be further appreciated in light of this disclosure, the claimed invention is not intended to be limited to implementation with drop ceilings of any particular configuration, but rather may be implemented with a wide variety of such grid infrastructures, standard and custom, and including any kind of grid materials (e.g., metal, plastics, etc) and intervening insulating materials.

Direct Lighting Architecture and Operation

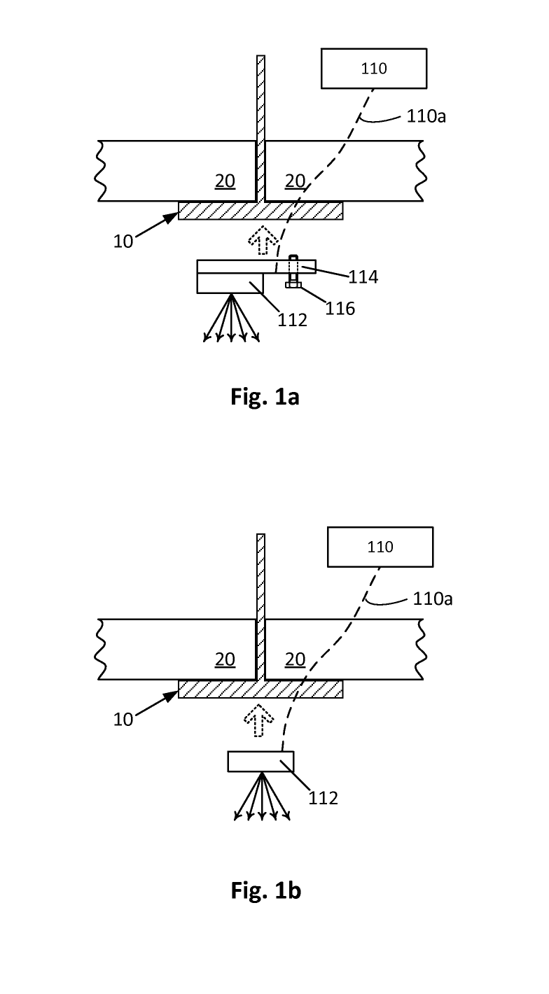

FIGS. 1a and 1b each illustrate a schematic side view of an example drop ceiling grid configured with integrated lighting in accordance with an embodiment of the present invention. As can be seen, a lighting system is provided which in this example case includes a light fixture 110, a light source 112, an optional mounting support 114 to which light source 112 may be operatively coupled, and one or more fasteners 116 configured to operatively couple light source 112 (with or without a mounting support 114) to a T-frame 10 (or other region/portion) of a drop ceiling support grid/matrix. As will be appreciated in light of this disclosure, lighting system may include additional, fewer, and/or different elements or components from those here described (e.g., diffusers, brightness enhancement films, polarizers, aesthetic enhancements, etc).

Light fixture 110 provides power to light source 112 via wiring 110a, and may include, for example ballasting circuitry, power conversion circuitry, logic control circuitry, and/or other typical fixture components. Numerous other configurations will be apparent in light of this disclosure. As can be seen, while light fixture 110 is electrically connected to the light source 112, it is structurally decoupled from the light source 112, as will be appreciated in light of this disclosure. Wire 110a can be any suitable connection medium for coupling necessary power and control to the light source 112. In alternative embodiment, this connection medium can be implemented wirelessly, if so desired, at least for providing control signals. In such cases, power could be provided by battery, scavenging, or other suitable power source, or any combination thereof. In any case, note that light source 112 structurally connects to an external surface of the support grid, and the light fixture 110 can structurally connect to an internal surface of the support grid, and the wire 110a can be discretely run between the two to provide a necessary connection medium.

Light source 112 may comprise one or more light emitting diodes (LEDs) configured to emit a wide range of light (e.g., visible light, infrared light, and/or ultraviolet light, etc) suitable for a given application. In some example cases, light source 112 may comprise a plurality of multi-color LEDs, which may provide a high optical efficiency while permitting a wide range of highly tunable emissions. In some instances, highly collimated/polarized light may be desirable, and thus, in accordance with an embodiment, light source 112 may comprise one or more laser diodes appropriately configured to provide such light. Other suitable types and configurations for light source 112 will depend on a given application and will be apparent in light of this disclosure.

As previously noted, in some cases light source 112 optionally may be operatively coupled with a mounting support 114. In accordance with an embodiment, mounting support 114 may be chosen, at least in part, based on its ability to: (1) provide sufficient mechanical support for light source 112; (2) provide a suitable electrical interface for any componentry/electronics to be operatively coupled with light source 112; (3) be operatively coupled (e.g., fastened or otherwise attached/mounted) to T-frame 10 by one or more fasteners 116; (4) provide a sufficient thermal pathway between light source 112 and T-frame 10. Thus, in one specific example embodiment, mounting support 114 may comprise a printed circuit board (PCB) (e.g., linear strip PCB having contact points for componentry including one or more LEDs, an edge connector for coupling to power and control circuitry, and conductive runs that electrically connect componentry to terminals of the edge connector so as to allow for functional lighting circuit). However, as previously noted, some embodiments of the present invention may not implement a discrete mounting support 114, and thus light source 112 instead may be mounted directly to T-frame 10, such as shown in the example embodiment of FIG. 1b. Other suitable mounting supports 114 will depend on a given application and will be apparent in light of this disclosure.

Also, as previously noted, mounting support 114 and/or light source 112 may be operatively coupled (e.g., fastened or otherwise attached/mounted) to T-frame 10 by one or more fasteners 116. In accordance with an embodiment, the one or more fasteners 116 may be chosen, at least in part, based on their ability to: (1) physically secure light source 112 to T-frame 10 (with or without inclusion of mounting support 114); and/or (2) provide sufficient physical contact and thus a thermal pathway between light source 112 and T-frame 10 (with or without inclusion of mounting support 114). Furthermore, in accordance with an embodiment, fasteners 116 may enable light source 112 (with or without optional mounting support 114) to be implemented, for example: (1) within the space enclosed by the drop ceiling (e.g., internal to/within the support grid/matrix of T-frames 10 of the drop ceiling); and/or (2) external to the space enclosed by the drop ceiling (e.g., external to/on the underside of the support grid/matrix of T-frames 10 of the drop ceiling). Thus, in some embodiments, the one or more fasteners 116 may comprise, for example, a bolt, a screw, a clamp, a tab-and-retainer system, a thermally conductive adhesive, solder, combinations thereof, etc. Other suitable configurations for the one or more fasteners 116 will depend on a given application and will be apparent in light of this disclosure.

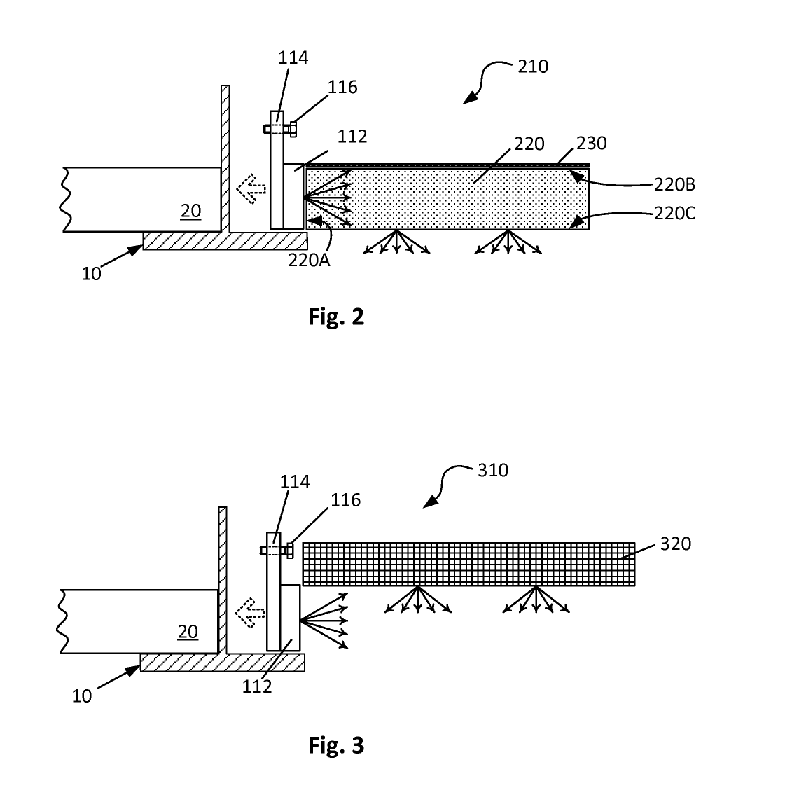

As can be seen in the example embodiments of FIGS. 1a-b, light source 112 is structurally decoupled from the fixture 110 and instead may be mounted on an exterior portion of a drop ceiling support grid, such that it is outside of the space enclosed by the drop ceiling. Consequently, light source 112 may be oriented to emit/direct light into the room being lit in any number of directions, such as downward or sideways at any angle. Collimators may be used if so desired, for highly directed lighting or the emitted light may simply diverge into the room. Thus, in some such embodiments, lighting system may be configured to emit/direct light away from the ceiling without implementation of additional lighting fixture structure (e.g., a lightguide, such as lightguide 220 discussed below with regard to FIG. 2; a reflective ceiling tile/panel, such as reflective tile 320 discussed below with regard to FIG. 3). As will be appreciated in light of this disclosure, and in accordance with the embodiment shown in FIGS. 1a-b, lighting system may be implemented without requiring substitution for a drop ceiling tile/panel 20. Other suitable configurations and variation for lighting system will depend on a given application and will be apparent in light of this disclosure.

In accordance with an embodiment, lighting system may have a very high optical efficiency (e.g., in the range of about 95-100%). In some instances, however, such direct lighting provided by lighting system may be undesirable for a given application (e.g., perceived brightness too high). Thus, and in accordance with an embodiment, it may be desirable to mitigate or otherwise reduce the brightness by utilizing indirect lighting techniques (e.g., the light may be bounced off a many-angled or otherwise rough surface/wall) and/or by operatively coupling a diffuser to lighting system. In either case, the optical efficiency of lighting system may be reduced (e.g., 88-98%). Other suitable indirect techniques/configurations will depend on a given application and will be apparent in light of this disclosure.

Indirect Lighting Architectures and Operation

FIG. 2 is a schematic side view of an example drop ceiling grid configured with integrated lighting in accordance with another embodiment of the present invention. As can be seen in this example case, this example lighting system includes an edge-lit lighting fixture 210 that is structurally decoupled from light source 112 and optional mounting support 114, and includes a lightguide 220 and an optional back reflector 230. As will be appreciated in light of this disclosure, light source 112, optional mounting support 114, and fastener(s) 116 may be configured much the same as previously described with reference to FIGS. 1a-b and elsewhere. As will further be appreciated in light of this disclosure, edge-lit lighting fixture 210 may include additional, fewer, and/or different elements or components from those here described (e.g., diffusers, brightness enhancement films, polarizers, aesthetic enhancements, ballasting circuitry, power conversion circuitry, logic control circuitry, connection medium such as wiring to electrically couple with light source 112, etc), and the claimed invention is not intended to be limited to any particular light fixture and/or drop ceiling configurations, but can be used with numerous configurations in numerous applications.

As can be seen in the example embodiment of FIG. 2, the light source 112 is mounted on an interior portion of a drop ceiling support grid/matrix (e.g., within the enclosed space above the drop ceiling surface, such as on an interior surface of T-frame 10) and oriented to emit/direct light into the light fixture 210. Once installed, the light source 112 effectively aligns with the edge of the lightguide 220 and back reflector 230 assembly, which in turn distributes and reflects the light downward into the room. Just as explained with reference to FIG. 1b and elsewhere, the mounting support 114 (e.g., PCB) is optional and may be left out in other embodiments, such as those where the grid support is fabricated from a non-conductive material and is effectively used as a PCB or substrate to hold componentry, or such as those where that portion of the grid is coated or otherwise treated with a non-conductive layer of material to which the LEDs or other illuminating devices of light source 112 (and any other components) can be fastened to and still properly function.

As can be seen from FIG. 2, light source 112 can be positioned proximate to the adjacent lightguide 220 and configured to emit/direct light therein. In one specific example embodiment, light source 112 may be physically touching an input edge 220A of lightguide 220. However, in some cases, it may be desirable to maintain a small gap (e.g., in the range of a few micrometers to a few millimeters) between light source 112 and input edge 220A to ensure suitable coupling of the light into lightguide 220.

Lightguide 220 may comprise an optical material chosen, at least in part, based on its: (1) ability to achieve total internal reflection (TIR) of at least a portion of the light provided by light source 112; (2) ability to transmit/emit the wavelength(s) of interest (e.g., visible, ultraviolet, infrared, etc) of the light provided by light source 112; (3) durability (e.g., resistance to fractures, scratches, warping, etc); (4) dimensions (e.g., weight, size, etc); and/or (5) cost (e.g., of replacement, repair, etc). Thus, in accordance with an embodiment, lightguide 220 may comprise a material such as, but not limited to: (1) a transparent polymer such as poly(methyl methacrylate) (PMMA), polycarbonate, etc.; (2) a transparent ceramic such as sapphire (Al₂O₃), yttrium aluminum garnet (YAG), etc.; and/or (3) a transparent glass. In some cases, lightguide 220 optionally may be implemented, for example: (1) with an optical and/or protective coating (e.g., anti-reflective, diffractive, scratch-resistant, etc); and/or (2) with additional optical componentry (e.g., collimating/diffusing optic sheets, microlens array, etc). Lightguide 220 may be substantially configured with any geometry suitable for a given application, such as, but not limited to: (1) a planar structure (e.g., a square/rectangular plate, a circular plate, an elliptical plate, etc); (2) a curved/non-planar structure (e.g., a three-dimensional structure having at least one curved/non-planar surface); and/or (3) other custom structure. Furthermore, the dimensions (e.g., length, width, height, weight, etc) of lightguide 220 may be customized for a given application. In accordance with an embodiment, lightguide 220 may be configured to be received and retained by, for example, a T-frame 10 (or other portion/region) of the support grid of a given drop ceiling. Thus, in one specific example embodiment, lightguide 220 may be configured with a square shape (e.g., having an area of about 2 ft.×2 ft.) or a rectangular shape (e.g., having an area of about 2 ft.×4 ft.), which may permit edge-lit lighting fixture 210 to be substituted, for instance, for a standard drop ceiling tile 20 in a desired location in the given drop ceiling support grid. Furthermore, in some cases lightguide 220 may be configured to extend up into the space enclosed by the drop ceiling (e.g., internal to/within the support grid/matrix of T-frames 10 of the drop ceiling) and/or to extend below the surface of the drop ceiling (e.g., to permit light to be directed horizontally along the ceiling). Other suitable configurations and/or materials for lightguide 220 will depend on a given application and will be apparent in light of this disclosure.

As will be further appreciated, permitting light to be emitted through back surface 220B of lightguide 220 may be undesirable for some applications (e.g., ceiling lighting applications). Thus, edge-lit lighting fixture 210 optionally may include the back reflector 230 proximately disposed or otherwise operatively coupled with back surface 220B of lightguide 220. When included, back reflector 230 may be configured to reflect/redirect light that otherwise would escape lightguide 220 through its back surface 220B back towards/through output surface 220C of lightguide 120. It may be desirable to ensure that back reflector 230 is implemented sufficiently proximate to back surface 220B of lightguide 220 (e.g., such that any gap there between is in the range of a few micrometers to a few millimeters) to ensure a sufficient amount of reflection suitable for a given application. The back reflector 230 may comprise, for example, a highly reflective material chosen, at least in part, based on its ability to reflect the light (e.g., visible, ultraviolet, infrared, etc) provided by light source 112. For instance, in one specific example embodiment, back reflector 230 comprises a metal film/layer such as, but not limited to aluminum, gold, silver, and alloys thereof, and/or any other materials having suitable reflectivity. Also, much like with lightguide 220, the configuration of back reflector 230 may be customized for a given application. For example, back reflector 230 may be configured to conform to the shape/curvature of or otherwise complement: (1) a three-dimensional lightguide 220 (e.g., a square/rectangular plate, a circular plate, an elliptical plate, etc); (2) a curved/non-planar lightguide 220 (e.g., a three-dimensional structure having at least one curved/non-planar surface); and/or (3) other customized lightguide 220. To this end, further note that the dimensions (e.g., length, width, thickness, etc) of back reflector 230, when included, may be customized for a given application. For instance, in one specific example embodiment, back reflector 230 may be configured for implementation with a square plate lightguide 220 (e.g., having an area of about 2 ft.×2 ft.) or a rectangular plate lightguide 220 (e.g., having an area of about 2 ft.×4 ft.), as previously discussed. In some cases, back reflector 230 may be dimensioned similarly to back surface 220B (e.g., substantially similar/identical areas at the interface between back surface 220B and back reflector 230) to ensure that a minimal amount of light (e.g., substantially no light or an otherwise acceptable amount) escapes through back surface 220B. In one example case, back reflector 230 is conformally coated onto or otherwise formed on back surface 220B. Other suitable lighting fixture configurations and/or materials for lightguide 220 and back reflector 230 will depend on a given application and will be apparent in light of this disclosure.

As will be appreciated in light of this disclosure, and in accordance with an embodiment, edge-lit lighting fixture 210 may be substituted for a drop ceiling tile/panel 20 (e.g., a standard 2 ft.×2 ft. or 2 ft.×4 ft. panel; a custom panel; etc). Other suitable configurations of edge-lit lighting fixture 210 will depend on a given application and will be apparent in light of this disclosure.

In accordance with an embodiment, edge-lit lighting fixture 210 may be configured to have an optical efficiency, for example, in the range of about 65-90% (e.g., greater than or equal to about 85%, greater than or equal to about 80%, greater than or equal to about 75%, greater than or equal to about 70%, etc). As will be appreciated in light of this disclosure, and in accordance with an embodiment, one or more of the aforementioned intensity reduction techniques (e.g., indirect lighting, diffuser use, etc) discussed with reference to FIG. 1 may be applied to edge-lit lighting fixture 210.

FIG. 3 is a schematic side view of an example drop ceiling support grid configured with integrated lighting in accordance with another embodiment of the present invention. As can be seen in this example case, the lighting system includes an edge-lit lighting fixture 310 that is structurally decoupled from light source 112 and optional mounting support 114, and includes a reflective ceiling tile/panel 320. As will be appreciated in light of this disclosure, light source 112, optional mounting support 114, and fastener(s) 116 may be configured much the same as previously described with reference to FIGS. 1a-b and 2, and elsewhere. As will further be appreciated in light of this disclosure, reflective tile lighting fixture 310 may include additional, fewer, and/or different elements or components from those here described (e.g., diffusers, brightness enhancement films, polarizers, aesthetic enhancements, ballasting circuitry, power conversion circuitry, logic control circuitry, connection medium such as wiring to electrically couple with light source 112, etc), and the claimed invention is not intended to be limited to any particular lighting fixture and/or drop ceiling configurations, but can be used with numerous configurations in numerous applications.

As can be seen in the example embodiment of FIG. 3, the light source 112 is mounted on an interior portion of a drop ceiling support grid/matrix (e.g., within the enclosed space above the drop ceiling surface, such as on an interior surface of T-frame 10) and oriented to emit/direct light into the light fixture 310. Once installed, the light source 112 effectively aligns with the area of the light fixture just below the reflective ceiling tile/panel 320, which in turn distributes and reflects the light downward into the room. As previously explained, the mounting support 114 (e.g., PCB) is optional and may be left out in other embodiments, and that previously discussion is equally applicable here.

Reflective tile 320 may comprise any material suitable for implementation in a drop ceiling and may be chosen, at least in part, based on: (1) durability (e.g., resistance to warping/damage from water, smoke, heat, etc); (2) dimensions (e.g., weight, size, etc); (3) surface patterning; (4) aesthetics; (5) satisfaction of seismic and fire safety codes/standards; (6) acoustic insulation qualities; and/or (7) cost (e.g., or replacement, repair, etc). In accordance with an embodiment, the reflectivity of reflective tile/panel 320 may be achieved by any number of suitable means, including, but not limited to: (1) impregnating, embedding, or otherwise integrating one or more reflective materials into at least a portion (e.g., a surface) of reflective tile/panel 320; (2) disposing a layer or film of one or more reflective materials on at least a portion (e.g., a surface) of reflective tile/panel 320; and/or (3) forming reflective tile/panel 320, in part or in whole, from one or more reflective materials. Other suitable techniques for obtaining a desired reflectivity from reflective tile/panel 320 will be apparent in light of this disclosure.

As will be appreciated, a number of factors may be considered in choosing a suitable reflective material, such as its ability to reflect the wavelength(s) of interest (e.g., visible, ultraviolet, infrared, etc) of the light provided by light source 112 and/or to evenly distribute incident light in a manner suitable for a given application. Thus, and in accordance with an embodiment, reflective tile 320 may implement a reflective material such as, but not limited to: (1) barium sulfate (BaSO₄); (2) polyethylene terephthalate (PET); (3) aluminum oxide (Al₂O₃); (4) titanium dioxide (TiO₂); and/or (5) calcium carbonate (CaCO₃). In some cases, one or more such materials may be included, for example, in a paint or other similar substance which may be applied to a surface of reflective tile/panel 320. Other suitable configurations and/or materials for reflective tile/panel 320 will depend on a given application and will be apparent in light of this disclosure.

In some instances, it may be desirable to convert the light provided by light source 112 remotely or otherwise downstream of light source 112. Therefore, and in accordance with one specific example embodiment, reflective tile/panel 320 may be configured to implement a phosphor material (e.g., on/in its surface) which functions to convert light received from light source 112 to light of a different wavelength. Reflective tile 320 may be substantially configured with any geometry suitable for a given application, such as, but not limited to: (1) a planar structure (e.g., a square/rectangular plate, a circular plate, an elliptical plate, etc); (2) a curved/non-planar structure (e.g., a three-dimensional structure having at least one curved/non-planar surface); and/or (3) other custom structure. Furthermore, the dimensions (e.g., length, width, height, etc) of reflective tile 320 may be customized for a given application. In accordance with an embodiment, reflective tile 320 may be configured to be received and retained by, for example, a T-frame 10 (or other portion/region) of the support grid/matrix of a standard/custom drop ceiling. Thus, in one specific example embodiment, reflective tile/panel 320 may be configured as a square plate (e.g., having an area of about 2 ft.×2 ft.) or as a rectangular plate (e.g., having an area of about 2 ft.×4 ft.), which may permit reflective tile lighting fixture 310 to be substituted, for instance, for a standard drop ceiling tile 20 in a given drop ceiling support grid/matrix. Furthermore, and in accordance with an embodiment, it may be desirable in some instances to configure reflective tile/panel 320 such that it may be recessed within a given drop ceiling support grid/matrix. Recessing of the reflective tile/panel 320 may be provided, for example: (1) by raising the reflective tile/panel 320 farther into the enclosed space above the drop ceiling relative to the light source 112; and/or (2) by lowering the light source 112 on T-frame 10 relative to reflective tile/panel 320. Other suitable techniques for recessing reflective tile 320 will depend on a given application and will be apparent in light of this disclosure.

As will be appreciated in light of this disclosure, and in accordance with an embodiment, reflective tile lighting fixture 310 may be substituted for a drop ceiling tile/panel 20 (e.g., a standard 2 ft.×2 ft. or 2 ft.×4 ft. panel; a custom panel; etc). Other suitable configurations of reflective tile lighting fixture 310 will depend on a given application and will be apparent in light of this disclosure.

In accordance with an embodiment, reflective tile lighting fixture 310 may be configured to have an optical efficiency, for example, in the range of about 65-98% (e.g., greater than or equal to about 95%, greater than or equal to about 90%, greater than or equal to about 85%, greater than or equal to about 80%, etc). As will be appreciated in light of this disclosure, and in accordance with an embodiment, one or more of the aforementioned intensity reduction techniques (e.g., indirect lighting, diffuser use, etc) discussed with reference to FIG. 1 may be applied to reflective tile lighting fixture 310.

Lighting Effects

As previously discussed, in some cases light source 112 may comprise, for example, one or more LEDs (multi-color or otherwise) configured to provide a wide range of highly tunable emissions. In accordance with an embodiment, such a light source 112 may be operatively coupled, for example, with a lightguide 220 to provide an edge-lit lighting fixture 210 capable of simulating a wide range of environmental conditions (e.g., a day or night sky) and/or producing specific lighting conditions, for instance, based on physiological considerations (e.g., to coincide with circadian rhythms, to alter or otherwise modify moods/behaviors, to foster a calm environment, etc). Other suitable uses of highly tunable light sources 112 will be apparent in light of this disclosure.

Furthermore, as will be appreciated in light of this disclosure and in accordance with an embodiment, any combination of systems shown in FIGS. 1a-b, 2 and 3 may be implemented with a given drop ceiling support grid/matrix to create a desired lighting effect within a given space. For instance, in one specific example embodiment, an ambient-lit room having ceiling wash and wall wash effects may be provided by utilizing a plurality of direct lighting (such as shown in FIGS. 1a-b) around the perimeter of the drop ceiling support grid/matrix (e.g., on the outermost frames of the support grid/matrix) while a plurality of edge-lit lighting fixtures (such as those shown in FIG. 2 or 3) are utilized elsewhere along the drop ceiling. Any number of lighting configurations/combinations can be used and the claimed invention is not intended to be limited to any particular fixturing scheme or lighting type.

Numerous embodiments will be apparent in light of this disclosure. One example embodiment provides a lighting system for a drop ceiling light application having a support grid framework for holding individual ceiling tiles. The lighting system includes a light fixture and a light source structurally decoupled from the light fixture and for emitting light, wherein the light source is configured to electrically connect to the light fixture and to structurally connect to the support grid framework. In some cases, the light source comprises one or more light emitting diodes (LEDs) or laser diodes. In some cases, the light source comprises a mounting support for coupling to the support grid framework. In some cases, the mounting support comprises a printed circuit board. In some cases, the system further includes a diffuser. In some cases, the light source is configured to structurally connect to an internal surface of the support grid framework, the internal surface being part of an inverted T shaped section of the support grid framework. In some cases, the light fixture is for structurally connecting to an internal surface of the support grid framework, and the light source is for structurally connecting to an external surface of the support grid framework. In some cases, the lighting fixture can be substituted for one of the ceiling tiles and can securely sit within the support grid framework, and the light source is for providing light laterally into lighting fixture and the light fixture is configured to direct that light downward. In one such case, the lighting fixture is an edge lit lighting fixture.

In another such case, the lighting fixture comprises a back reflector. In some cases, the light source is coupled directly to the support grid framework without an intervening substrate (e.g., no PCB, etc).

Another embodiment provides a lighting system for a drop ceiling light application having a support grid framework for holding individual ceiling tiles. In this example case, the lighting system includes a light fixture and a light source for electrically connecting to the light fixture and emitting light and comprising one or more light emitting diodes (LEDs) or laser diodes populated on a printed circuit board. The light source is structurally decoupled from the light fixture and configured to structurally connect to the support grid framework. In some cases, the light source is configured to structurally connect to an internal surface of the support grid framework, the internal surface being part of an inverted T shaped section of the support grid framework. In some cases, the light fixture is for structurally connecting to an internal surface of the support grid framework, and the light source is for structurally connecting to an external surface of the support grid framework. In some cases, the lighting fixture can be substituted for one of the ceiling tiles and can securely sit within the support grid framework, and the light source is for providing light laterally into lighting fixture and the light fixture is configured to direct that light downward. In one such example case, the lighting fixture is an edge lit lighting fixture. In another such example case, the lighting fixture comprises a back reflector.

Another embodiment of the present invention provides a drop ceiling lighting method. The method includes providing a light fixture, and providing a light source structurally decoupled from the light fixture, the light source for emitting light. The method further includes electrically connecting the light source to the light fixture, and structurally connecting the light source to the support grid framework. Note the order of operations is not necessarily important (e.g., electrical connections can be made after structural connections, etc). In some cases, the light source comprises a printed circuit board, and structurally connecting the light source to the support grid framework includes mounting the printed circuit board to the support grid framework. In some cases, the light source is structurally connected to an internal surface of the support grid framework, the internal surface being part of an inverted T shaped section of the support grid framework. In some cases, the light fixture is structurally connected to an internal surface of the support grid framework, and the light source is structurally connected to an external surface of the support grid framework. In some cases, the lighting fixture can be substituted for one of the ceiling tiles and can securely sit within the support grid framework, and the light source is for providing light laterally into lighting fixture and the light fixture is configured to direct that light downward. In some such cases, the lighting fixture is an edge lit lighting fixture. In other such cases, the lighting fixture comprises a back reflector. In some cases, the light source is coupled directly to the support grid framework without an intervening substrate.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A lighting system for a drop ceiling light application having a support grid framework for holding individual ceiling tiles, the lighting system comprising:
a light fixture; and
a light source structurally decoupled from the light fixture and for emitting light, wherein the light source is configured to electrically connect to the light fixture and to structurally connect to the support grid framework.

2. The system of claim 1 wherein the light source comprises one or more light emitting diodes (LEDs) or laser diodes.

3. The system of claim 1 wherein the light source comprises a mounting support for coupling to the support grid framework.

4. The system of claim 3 wherein the mounting support comprises a printed circuit board.

5. The system of claim 1 further comprising a diffuser.

6. The system of claim 1 wherein the light source is configured to structurally connect to an internal surface of the support grid framework, the internal surface being part of an inverted T shaped section of the support grid framework.

7. The system of claim 1 wherein the light fixture is for structurally connecting to an internal surface of the support grid framework, and the light source is for structurally connecting to an external surface of the support grid framework.

8. The system of claim 1 wherein the lighting fixture can be substituted for one of the ceiling tiles and can securely sit within the support grid framework, and the light source is for providing light laterally into lighting fixture and the light fixture is configured to direct that light downward.

9. The system of claim 8 wherein the lighting fixture is an edge lit lighting fixture.

10. The system of claim 8 wherein the lighting fixture comprises a back reflector.

11. The system of claim 1 wherein the light source is coupled directly to the support grid framework without an intervening substrate.

12. A lighting system for a drop ceiling light application having a support grid framework for holding individual ceiling tiles, the lighting system comprising:
a light fixture; and
a light source for electrically connecting to the light fixture and emitting light and comprising one or more light emitting diodes (LEDs) or laser diodes populated on a printed circuit board, the light source structurally decoupled from the light fixture and configured to structurally connect to the support grid framework.

13. The system of claim 12 wherein the light source is configured to structurally connect to an internal surface of the support grid framework, the internal surface being part of an inverted T shaped section of the support grid framework.

14. The system of claim 12 wherein the light fixture is for structurally connecting to an internal surface of the support grid framework, and the light source is for structurally connecting to an external surface of the support grid framework.

15. The system of claim 12 wherein the lighting fixture can be substituted for one of the ceiling tiles and can securely sit within the support grid framework, and the light source is for providing light laterally into lighting fixture and the light fixture is configured to direct that light downward.

16. The system of claim 15 wherein the lighting fixture is an edge lit lighting fixture.

17. The lighting fixture of claim 15 wherein the lighting fixture comprises a back reflector.

18. A drop ceiling lighting method, comprising:
providing a light fixture;
providing a light source structurally decoupled from the light fixture, the light source for emitting light;
electrically connecting the light source to the light fixture; and
structurally connecting the light source to the support grid framework.

19. The method of claim 18 wherein the light source comprises a printed circuit board, and structurally connecting the light source to the support grid framework includes mounting the printed circuit board to the support grid framework.

20. The method of claim 18 wherein the light source is structurally connected to an internal surface of the support grid framework, the internal surface being part of an inverted T shaped section of the support grid framework.

21. The method of claim 18 wherein the light fixture is structurally connected to an internal surface of the support grid framework, and the light source is structurally connected to an external surface of the support grid framework.

22. The method of claim 18 wherein the lighting fixture can be substituted for one of the ceiling tiles and can securely sit within the support grid framework, and the light source is for providing light laterally into lighting fixture and the light fixture is configured to direct that light downward.

23. The method of claim 22 wherein the lighting fixture is an edge lit lighting fixture.

24. The method of claim 22 wherein the lighting fixture comprises a back reflector.

25. The method of claim 18 wherein the light source is coupled directly to the support grid framework without an intervening substrate.
